(19) United States
(12) Patent Application Publication
(10) Pub. No.: US 2005/0094800 A1
(43) Pub. Date: May 5, 2005

(54) Automated, wrap-around telephone dialing

(75) Inventor: Michael E. Jansen, Santa Ana, CA (US)

Correspondence Address: MCDERMOTT, WILL & EMERY, Suite 3400, 2049 Century Park East, Los Angeles, CA, 90067, US

(73) Assignee: MEJansen Development Company LLC

(21) Appl. No.: 10/697,205

(22) Filed: Oct. 30, 2003

(51) Int. Cl. H04M 1/00; H04M 3/00

(52) U.S. Cl. 379/352; 379/355.01

(57) ABSTRACT

A wrap-around dialer may include a memory for storing a first long distance access code and a processor. The processor may be configured to receive a string of numbers from a dialing device and to deliver the first long distance access code and at least a portion of the string of numbers into a telephone line, if the string of numbers includes a second long distance access code. The processor may also be configured to deliver the full string of numbers into the telephone line without the first long distance access code, if the string of numbers does not include the second long distance access code. Related processes and other features are also disclosed.

### BACKGROUND

1. Field

This disclosure relates to telephone dialing systems, including secondary long-distance carrier services.

2. Description of Related Art

Each telephone subscriber must usually select a long distance carrier that the telephone subscriber wishes to handle the long distance calls that are made by the subscriber. Unfortunately, the prices charged by the selected carrier are often higher than what can otherwise be obtained.

In an effort to give subscribers an opportunity to place long distance calls at a lower cost, without changing its default long distance carriers, several secondary forms of long distance carrier service have emerged.

For example, long distance calls may be charged to a credit card. To do so, the user must first enter an access code, such as a designated 800 number followed by his credit card number. The number that the user wishes to actually dial may then be entered. (In some cases, the number that the user wishes to dial is entered after dialing the 800 number, but before the credit card number is entered.) After the call is completed, the subscriber may receive a billing statement from the long distance calling card company.

Another popular approach is to first dial a long distance access code, such as 10 10 221. Thereafter, the subscriber dials the desired long distance number and the charge for the call is placed on the subscriber's telephone bill as a charge to the telephone number represented by the long distance access code.

All of these secondary approaches to obtaining lower, long distance dialing rates are referred to in this disclosure as “wrap-around” dialing.

Unfortunately, many subscribers do not make effective use of a less expensive, wrap-around dialing service. Many are simply not aware of the availability of the service. Others may be flustered by the complexity. Still others may not recall the necessary long distance access code when it is needed. Still others may not be able to readily differentiate between calls that will benefit from wrap-around dialing and calls that will not.

### SUMMARY OF INVENTION

A wrap-around dialer may include a memory for storing a first long distance access code and a processor. The processor may be configured to receive a string of numbers from a dialing device and to deliver the first long distance access code and at least a portion of the string of numbers into a telephone line, if the string of numbers includes a second long distance access code. The processor may also be configured to deliver the full string of numbers into the telephone line without the first long distance access code, if the string of numbers does not include the second long distance access code.

The processor may be configured to disconnect the dialing device from phone line while receiving at least a portion of the string of numbers from the dialing device.

The processor may be configured to connect the dialing device to the phone line after receiving at least a portion of the string of numbers.

The first long distance access code may be different from the second long distance access code.

The second long distance access code may be the digit “1” at the beginning of the string of numbers.

The second long distance access code may be the digits “011” at the beginning of the string of numbers.

The second long distance access code may be either the digit “1” or the digits “011” at the beginning of the string of numbers.

The delivered portion of the string of numbers may be the string of numbers without the second long distance access code.

The processor may be configured to deliver the first long distance access code into the telephone line before the portion of the string of numbers.

The processor may be configured to begin delivering the first long distance access code into the telephone line while there is a dial tone on the telephone line.

The dialing device may be a telephone.

The dialing device may be integral with the wrap-around dialer.

A wrap-around dialer may include means for storing a first long distance access code, means for receiving a string of numbers from a dialing device, means for delivering the first long distance access code and at least a portion of the string of numbers into a telephone line if the string of numbers includes a second long distance access code, and means for delivering the full string of numbers into the telephone line without the first long distance access code if the string of numbers does not include the second long distance access code.

A wrap-around dialing process may include receiving a string of numbers from a dialing device, delivering a first long distance access code and at least a portion of the string of numbers into a telephone line when the string of numbers includes a second long distance access code, and delivering the full string of numbers into the telephone line without the first long distance access code when the string of numbers does not include the second long distance access code.

The process may include disconnecting the dialing device from the phone line while receiving at least a portion of the string of numbers from the dialing device.

The process may include connecting the dialing device to the phone line after receiving at least a portion of the string of numbers.

The first long distance access code may be different from the second long distance access code.

The second long distance access code may be the digit “1” at the beginning of the string of numbers.

The second long distance access code may be the digits “011” at the beginning of the string of numbers.

The second long distance access code may be either the digit “1” or the digits “011” at the beginning of the string of numbers.

The delivered portion of the string of numbers may be the string of numbers without the second long distance access code.

The process may include delivering the first long distance access code into the telephone line before the portion of the string of numbers.

The process may include beginning the delivery of the first long distance access into the telephone line while there is a dial tone on the telephone line.

The dialing device may be a telephone.

These, as well as other objects, features and benefits will now become clear from a review of the following detailed description of illustrative embodiments and the accompanying drawings.

### BRIEF DESCRIPTION OF DRAWINGS

FIG. 1 is a block diagram of an embodiment of a wrap-around telephone dialer that is separate from a dialing device.

FIG. 2 is a flow diagram of an embodiment of a wrap-around dialer.

FIG. 3 is a block diagram of an embodiment of a wrap-around telephone dialer that is integral with a dialing device.

### DETAILED DESCRIPTION OF ILLUSTRATIVE EMBODIMENTS

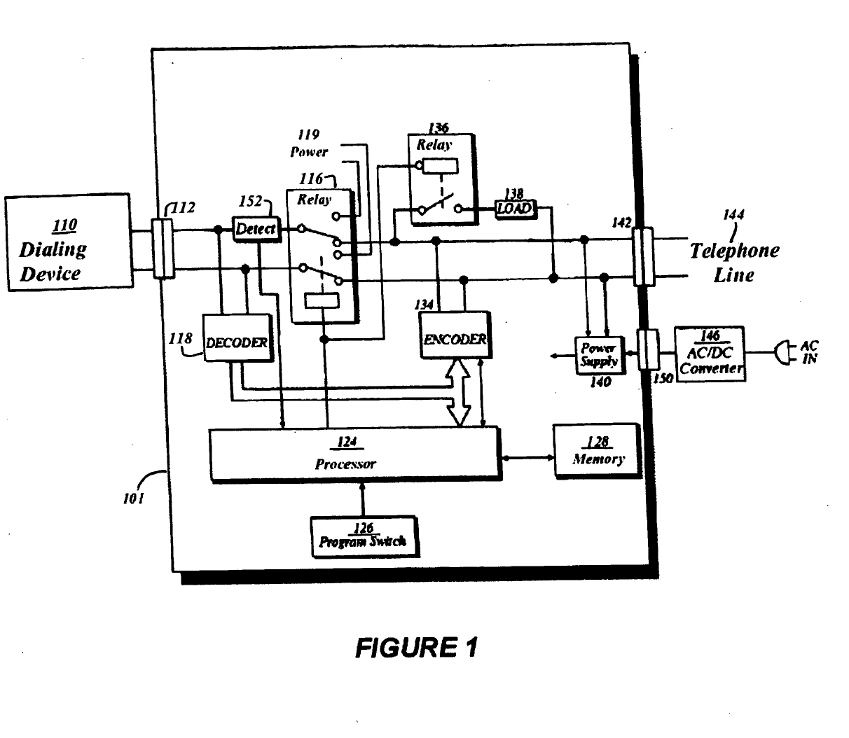

FIG. 1 is a block diagram of an embodiment of a wrap-around telephone dialer that is separate from a dialing device.

As shown in FIG. 1, a wrap-around telephone dialer 101 may include a dialing device 110 that is connected through a connector 112 to a decoder 118, a detector 152 and a relay 116. The decoder 118 may be configured to decode multi-frequency dialing tones, pulses or any other form of dial encoding coming from the dialing device 110 and to deliver that decoded information to a processor 124. The processor may include a microprocessor or a microcontroller. The detector 152 may be configured to detect an “off-hook” condition in the dialing device 110 and to deliver that information to the processor 124.

The dialing device 110 may be a telephone, a cell phone, a PC, or any other type of device that is capable of dialing telephone numbers. The embodiment of the wrap-around dialer in FIG. 1 is configured to work with a telephone and may be modified in ways that will become apparent if another type of dialing device is used.

A program switch 126 may be in communication with the processor 124 for the purpose of controlling the mode of the processor 124 and, in particular, for switching the processor 124 between a normal operation mode and a programming mode. During the normal mode, numbers to be dialed may be entered into the dialing device 110. During the programming mode, an access code may be programmed into the wrap-around telephone dialer 101.

A memory 128 may be in communication with the processor 124. Among other information, the memory 128 may hold a long distance access code that may be used by the processor 124 in the manner described below. The memory may include a non-volatile memory.

The relay 116 in the powered state shown in FIG. 1 may connect the dialing device 110 to a telephone line 144 through a connector 142. When switched to its opposite state, the relay 116 may disconnect the dialing device 110 from the telephone line 144 and, instead, may connect the dialing device 110 to an independent source of power 119.

A relay 136 may also be provided that acts in association with a load 138, such as a resistor, to impose a load in its un-powered state on the telephone line 144. From the perspective of the telephone line, the load may look similar to the load that is normally presented by the dialing device 110 when it is “off hook.”

Both relays may be connected in parallel, as shown in FIG. 1. When power is applied to both, the relay 116 may connect the dialing device 110 to the telephone line 144, while the relay 136 may remove the load 138 from the telephone line. When power is removed, the relay 116 may cause the dialing device 110 to be removed from the telephone line 144, while the relay 136 may cause the load 138 to be placed across the telephone line 144.

An encoder 134 may be provided to encode numbers generated by the processor 124 for delivery into the telephone line 144. The encoder 134 may produce multi-frequency dialing tones, dialing pulses or any other form of coding. The coding may be compatible with the encoding needed by the telephone line.

An AC/DC converter 146 and an internal power supply 140 may also be provided to generate the power for one or more of the components in the wrap-around telephone dialer 101.

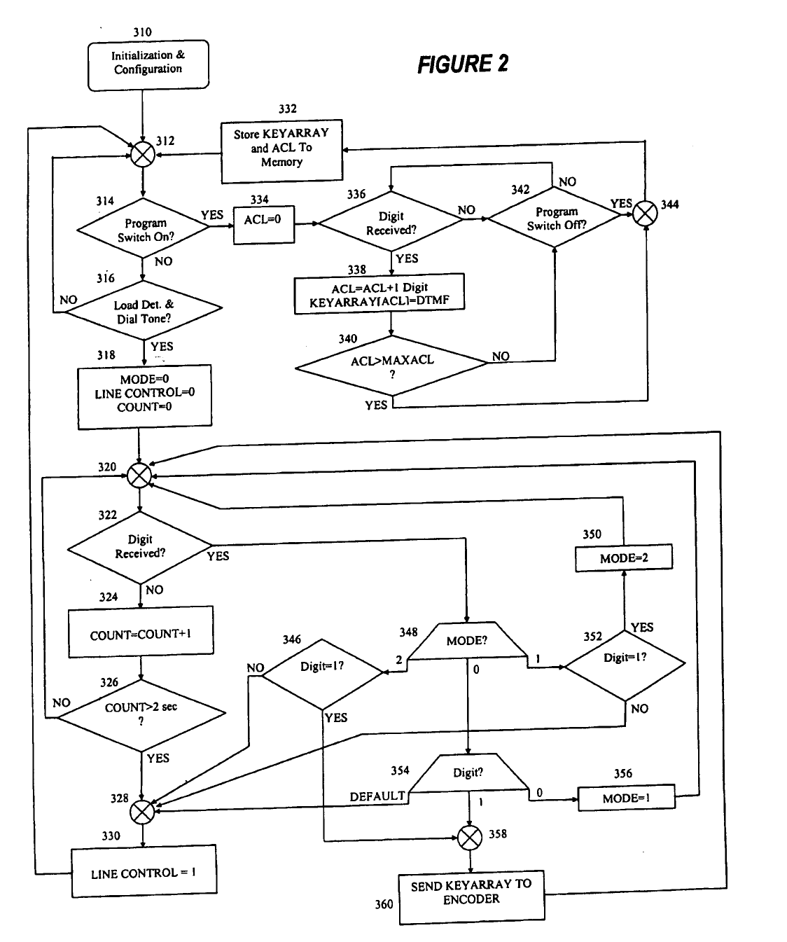

FIG. 2 is a flow diagram of an embodiment of a wrap-around telephone dialer. FIG. 2 will now be described in conjunction with the embodiment of the wrap-around telephone dialer 101 shown in FIG. 1. The same process or different processes may also be applies to other embodiments.

As shown in FIG. 2, the dialer shown in FIG. 1 may first go through an initialization and configuration step after power is applied, as shown in an Initialization Configuration block 310. The processor 124 may then test to determine whether the program switch 126 is on, as reflected by a Program Switch On? decision block 314. If the program switch 126 is on, this may indicate that the user of the wrap-around telephone dialer 101 wishes to program the wrap-around telephone dialer 101 with a wrap-around long distance access code, such as 10 10 221 or a credit card 800 number followed by the credit card number. To facilitate this, a variable indicating the access code length ACL may be initialized by the processor 124 to be equal to 0, as reflected by an ACL=0 block 334.

The processor 124 may next test to see whether the decoder 118 has decoded a number dialed by the dialing device 110, as reflected by a Digit Received? decision block 336. If such a digit has been detected, this means that the subscriber has entered a digit of the long distance access code. In this instance, the stored length of the long distance access code ACL may be incremented and the entered digit may be stored in an array that represents the long distance access code, as reflected by an ACL=ACL+1 and KeyArray[ACL]=Digit block 338.

The processor 124 may next test to see whether the access code length equals a maximum access code length that the system may permit, as reflected by an ACL=MAXACL? decision block 340. If it does not, the processor 124 may next check whether the program switch 126 has been switched off, as reflected by a Program Switch Off? decision block 342. If the Program Switch 126 is still on, the processor may return to the Digit Received? decision block 336 to receive and store further digits of the long distance access code.

If the Digit Received? block fails to receive a new digit, the processor 124 may next determine whether the program switch has been turned off, as reflected by the Program Switch Off? decision block 342.

Once the maximum allowable length of the long distance access code ACLMAX has been entered, the ACL=MAXACL? decision block 340 may be answered by the processor 124 in the affirmative. Thereafter, the entire value of the KeyArray and its length may be stored in the memory 128, as reflected by a Store KeyArray and ACL to Memory block 332.

From the subscriber's perspective, the subscriber may turn the program switch 126 on and then enter the access code, such as 10 10 221 or the 800 number of his credit card followed by the credit card number. The striking of the “#” key or some other key may be interpreted by the processor 124 as a pause instruction, to be used later in dialing, as described below. Once the user enters the maximum allowable number of long distance access code digits or switches the program switch 126 off, the long distance access code that he enters may be stored in the memory 128. Of course, the processor 124 may also be configured to allow this entire process to be repeated, and thus for a stored long distance access code to be changed.

When the program switch 126 is off, the processor 124 may check whether the dialing device 110 has been taken off hook and whether there is a dial tone, as reflected by a Load Det. and Dial Tone? decision block 316. The detector 152 may perform this function and provide the results of its analysis to the processor 124. The decoder 118 may also be involved in this process, particularly in connection with the detection of the dial tone.

Once a determination has been made that the dialing device 110 has been taken off hook and that there is a dial tone, the processor 124 may ready itself to analyze the digits that are delivered from the dialing device 110 for the purpose of determining whether a long distance call is being placed. If so, and as will now be seen, the processor 124 may cause the stored long distance access code to be injected into the digits that are delivered into the telephone line 144, followed by the long distance number that is dialed. If the processor 124 determines that a long distance number has not been dialed, on the other hand, only the number that has been dialed may be delivered to the telephone line 144. The long distance access code may not be included.

As a first step in the analysis process, certain internal variables may be initialized.

One variable that may be initialized is a “Mode” variable. The mode variable may indicate the state of the analysis process. A Mode value of “0” may indicate that the first digit is being analyzed. A Mode value of “1” may indicate that the first digit has been analyzed and was found to be a “0.” A Mode value of “2” may indicated that the second digit has been analyzed and found to be a “1.”

Another variable that may be initialized is the “Line Control.” A value of “0” may mean that the relay 116 should be opened so that the dialing device 110 is not connected to the telephone line 144. A value of “0” may mean that the relay 116 should be closed so that the dialing device 110 is connected to the telephone line 144.

A “Count” variable may also be used to monitor the delay between digits that are received from the dialing device 110. If the delay exceeds a threshold amount, the dialing device 110 may be disconnected from the telephone line 144. The specific details of these operations will now be described.

After determining that the dialing device 110 has been taken off hook and that there is a dial tone, as reflected by the Load Det. and Dial Tone? decision block 316, the Mode, Line Control and Count variables may be initialized to “0,” as reflected by a Mode=0, Line Control=0 and Count=0 block 318.

Setting the Line Control to 0 may cause the switch 316 to open the connection between the dialing device 110 and the telephone line 144, while at the same time causing the load 138 to be placed across the telephone line 144 through the actuation of the relay 136.

The processor 124 may next seek to determine whether a digit is received from the dialing device 104, as detected by the decoder 118, as reflected in a Digit Received? decision block 322. If a digit is not received, the count may be incremented, as reflected by a Count=Count+1 block 324. The incremented count may then be compared to a threshold, such as 2 seconds, as reflected by a Count>2 sec? decision block 326. If the threshold has not been reached, the processor 124 may cause the processor 124 to continue to wait for a digit from the dialing device 110. If the threshold has been reached, on the other hand, the Line Control may be set equal to 1, as reflected by a Line Control=1 block 330, thus connecting the dialing device 110 to the telephone line 144.

Once a digit is received from the dialing device 110, a determination may next be made as to the value of the Mode parameter, as reflected by a Mode? determination block 348. As explained above, the Mode variable is initialized to 0, as reflected by the Mode=0, Line Control=0 and Count=0 block 318. Thus, the first time the value of the Mode variable is tested by the Mode? decision block 348, the value may be 0.

The processor 124 may next examine the value of the digit that has been received from the dialing device 110, as reflected by a Digit? decision block 354. If the value is a digit other than a 1 or 0, this may indicate that a local call is being made. In this event, the Line Control value may be set to 1, as reflected by the Line Control=1 block 330, causing the dialing device 110 to be directly connected to the telephone line 144. In this case, the full string of numbers from the dialing device 110 may be delivered directly into the telephone line 144, followed by the normal types of communication. The processor 124 may operate quickly enough such that the first digit is also delivered into the telephone line 144. Alternatively, the processor 124 may inject the first digit into the telephone line 144 by directing the encoder 134 to do so. Alternatively, the processor 124 may delay the connection of the dialing device 110 to the telephone line 144 until after the processor 124 receives the full string of dialed numbers from the dialing device 110. In this embodiment, the processor 124 may direct the encoder 134 to simply rebroadcast that same string of dialed numbers from the dialing device 110 into the telephone line 144 and, thereafter, to connect the dialing device 110 to the telephone line 144.

If the first digit that is received from the dialing device 110 is a 1, on the other hand, this may mean that a long distance call within the United States is being dialed and that the subsequent digits represent the actual telephone number that is desired. In this instance, the processor 124 may be configured to deliver the long distance access code that is stored in the memory 128 to the encoder 134 for delivery into the telephone line 144, as reflected by the Send KeyArray to Encoder block 360. The actual number being dialed may then follow. Subsequent numbers may be sent directly from the dialing device 110 into the telephone line 144, in which case the relay 116 may be activated after the detection of the initial “1.” Alternatively, the processor 124 may receive the full string of numbers from the dialing device 110 and then cause that string to be replicated and sent to the telephone line by issuing appropriate instructions to the encoder 134.

The initial “1” may or may not be included with the string of numbers that is actually delivered into the telephone line, depending upon the requirements of the wrap-around long distance carrier service. The “1” may be supplemented or replaced by additional codes, again depending upon the requirements of the wrap-around long distance carrier.

If the first digit from the dialing device 110 is a “0,” on the other hand, this indicates the possibility of a long distance call outside of the United States. In this event, the processor 124 may change the value of the Mode variable to 1, as reflected by a Mode=1 block 356. The processor 124 may then return to receive the next digit from the dialing device 110, as reflected by the Digit Received? decision block 322.

If the next digit is received within the deadline of the Count, a decision may next be made as to whether the second digit is a “1,” as reflected by a Digit=1 decision block 352. If the second digit is a 1, this continues to indicate the possibility of a long distance call outside of the United States. In this event, the Mode variable may be set to 2, as reflected by a Mode=2 block 350 and the processor 124 is ready to receive the third digit, as reflected by the Digit Received? decision block 322.

If a third digit is received within the deadline of the Count, the processor 124 may next determine whether the third digit is also a “1,” as reflected by a Digit=1 ? decision block 346. If it is, this may indicate that a long distance call outside of the United States is desired. In this instance, the processor 124 may proceed to inject the long distance access code that is stored in the memory 128 into the telephone line, as reflected by the Send KeyArray to Encoder block 360. The remaining digits from the dialing device 110 may also be entered into the telephone line 144 in accordance with one of the procedures discussed above in connection with the long distance call that is being dialed in the United States. If either the second or third digits are not a “1,” after having first received a “0,” this may indicate that a long distance call is not being placed. In this event, the full string of digits may then be delivered into the telephone line 144 without the long distance access code, as discussed above following the receipt of an initial digit that is not a “0” or a “1.”

As illustrated in FIG. 1, the dialing device 110 may be separate from the wrap-around dialer 101. In this embodiment, the dialing device 110 may be connected to the wrap-around telephone dialer through a connector 112, and the wrap-around dialer may be connected to the telephone line through a connector 142 and to the AC/DC converter 146 through a connector 150.

The actual separation distance between wrap-around telephone dialer 101 and the dialing device 110 may be small, such that the two units are next to one another, or may be large, such that the two units are in different rooms. Indeed, the wrap-around telephone dialer 101 may be located in a different building from the dialing device 110, such as within a local telephone company central office. In this later case, the local telephone company might offer the wrap around dialer as an optional service. The system might be configured to allow the subscriber to remotely program the wrap around dialer from his home entering, for example, a special code (or dialing a special number) to place the system in the programming mode.

A single wrap-around telephone dialer, such as the one shown in FIG. 1, may also be multiplexed between a plurality of dialing devices using appropriate multiplexing technology. The wrap-around telephone dialer could also be a node on a network system, such as a LAN, WAN and/or the Internet.

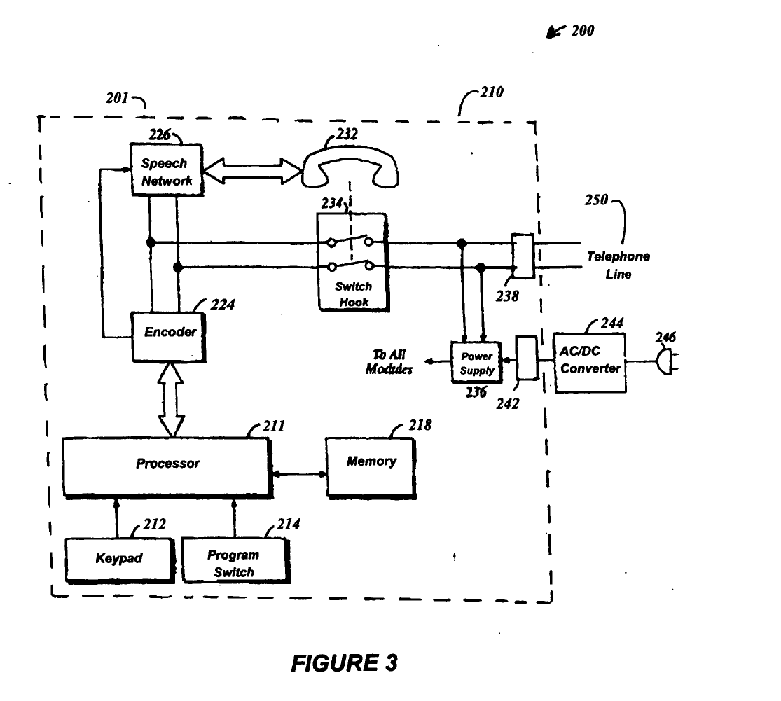

The wrap-around auto dialer may also be configured to contain an integral dialing device, as shown in FIG. 3. FIG. 3 is a block diagram of an embodiment of a wrap-around telephone dialer that is integral to a dialing device.

The components in FIG. 3 are the same as in FIG. 1, with the following exceptions. First, there may be no external dialing device. Instead, a telephone handset 232 may be connected to a speech network 226 that processes the signals to and from the handset 232 in accordance with well known techniques. The keypad that is often a part of the dialing device may be included as a separate component in the integral embodiment in FIG. 3 and, in particular, as a keypad 212. There may be no need for a decoder and detector, as the integral nature of the circuitry allows the processor 211 to be fully aware of the status of the dialing effort by virtue of the connection of the keypad 212 to the processor 211. The integral wrap-around auto dialer 201 may be connected to the telephone line 250 through a connector 238. It may similarly be connected to an AC/DC converter 244 that is connected to a source of power through a plug 246 through a connector 242. There may also be no need for relays, but rather only an on/off hook switch 234. All other aspects of the processor 211 may function in the same or comparable way as described above in connection with the processor 124 in FIG. 1. A voice recognition system may also be added or used instead of the keypad 212 to allow desired numbers to be requested by voice.

The various components and process steps may be implemented with a broad variety of technology, including hardware, software, and combinations of both. The processing components may be dedicated to the function of the wrap-around auto dialer or may be part of a more generalized computing system, such as a PC.

Although the long distance access code has thus-far been described as being injected into the telephone line as a prefix, followed by the actual number to be dialed, the reverse sequence or another sequence may also be employed.

Certain tests could also be eliminated or added. For example, the test for the maximum length of the KeyArray variable might be eliminated, as well as the Count test for a threshold delay between dialed digits.

Similarly, although the discussion has thus-far focused on a single long distance access code, multiple access codes could be entered and stored in the wrap-around telephone dialer. In this embodiment, different access codes might be used at different times or in connection with different strings of numbers from the dialing device, all possibly to facilitate maximum savings. For example, one access code might be the least expensive for overseas long distance calls while another might be the least expensive for U.S. long distance codes. In such a case, the dialer may be configured to accept two access codes, one for long distance calls within the U.S. (typically signaled by a “1” as the first digit) and the second for long distance calls outside of the U.S. (typically signaled by a “011” as the first digits).

Similarly, although only the initial digits of the string of numbers from the dialing device have been examined for the purpose of determining whether a long distance call is being made, other embodiments could examine other digits in addition or instead, such as digits at the end of the string.

In short, the concepts, features, benefits and processes that have thus-far been described are merely illustrative. Protection is limited solely by the claims that now follow and their equivalents.

1. A wrap-around dialer comprising:
a memory for storing a first long distance access code; and
a processor configured to:
receive a string of numbers from a dialing device;
deliver the first long distance access code and at least a portion of the string of numbers into a telephone line if the string of numbers includes a second long distance access code; and,
deliver the full string of numbers into the telephone line without the first long distance access code if the string of numbers does not include the second long distance access code.

2. The dialer of claim 1 wherein the processor is also configured to disconnect the dialing device from phone line while receiving at least a portion of the string of numbers from the dialing device.

3. The dialer of claim 2 wherein the processor is also configured to connect the dialing device to the phone line after receiving at least a portion of the string of numbers.

4. The dialer of claim 1 wherein the first long distance access code is different from the second long distance access code.

5. The dialer of claim 1 wherein the second long distance access code is the digit “1” at the beginning of the string of numbers.

6. The dialer of claim 1 wherein the second long distance access code is the digits “011” at the beginning of the string of numbers.

7. The dialer of claim 1 wherein the second long distance access code is either the digit “1” or the digits “011” at the beginning of the string of numbers.

8. The dialer of claim 1 wherein the delivered portion of the string of numbers is the string of numbers without the second long distance access code.

9. The dialer of claim 1 wherein the processor is also configured to deliver the first long distance access code into the telephone line before the portion of the string of numbers.

10. The dialer of claim 9 wherein the processor is also configured to begin delivering the first long distance access code into the telephone line while there is a dial tone on the telephone line.

11. The dialer of claim 1 wherein the dialing device is a telephone.

12. The dialer of claim 1 wherein the dialing device is integral with the wrap-around dialer.

13. A wrap-around dialer comprising:
means for storing a first long distance access code; and
means for receiving a string of numbers from a dialing device;
means for delivering the first long distance access code and at least a portion of the string of numbers into a telephone line if the string of numbers includes a second long distance access code; and
means for delivering the full string of numbers into the telephone line without the first long distance access code if the string of numbers does not include the second long distance access code.

14. A wrap-around dialing process comprising:
receiving a string of numbers from a dialing device;
delivering a first long distance access code and at least a portion of the string of numbers into a telephone line when the string of numbers includes a second long distance access code; and
delivering the full string of numbers into the telephone line without the first long distance access code when the string of numbers does not include the second long distance access code.

15. The process of claim 13 further comprising disconnecting the dialing device from phone line while receiving at least a portion of the string of numbers from the dialing device.

16. The process of claim 14 further comprising connecting the dialing device to the phone line after receiving at least a portion of the string of numbers.

17. The process of claim 13 wherein the first long distance access code is different from the second long distance access code.

18. The process of claim 13 wherein the second long distance access code is the digit “1” at the beginning of the string of numbers.

19. The process of claim 13 wherein the second long distance access code is the digits “011” at the beginning of the string of numbers.

20. The process of claim 13 wherein the second long distance access code is either the digit “1” or the digits “011” at the beginning of the string of numbers.

21. The process of claim 13 wherein the delivered portion of the string of numbers is the string of numbers without the second long distance access code.

22. The process of claim 13 further comprising delivering the first long distance access code into the telephone line before the portion of the string of numbers.

23. The process of claim 21 further comprising beginning the delivery of the first long distance access into the telephone line while there is a dial tone on the telephone line.

24. The process of claim 13 wherein the dialing device is a telephone.
